(19) United States
(12) Patent Application Publication
(10) Pub. No.: US 2006/0184489 A1
(43) Pub. Date: Aug. 17, 2006

(54) Genetic knowledgebase creation for personalized analysis of medical conditions

(75) Inventors: Allison Leigh Weiner, Milwaukee, WI (US); Gopal B. Avinash, New Berlin, WI (US)

Correspondence Address: Patrick S. Yoder;FLETCHER YODER, P.O. Box 692289, Houston, TX, 77269-2289, US

(73) Assignee: General Electric Company

(21) Appl. No.: 11/015,542

(22) Filed: Dec. 17, 2004

(51) Int. Cl. G06N 5/02

(52) U.S. Cl. 706/46

(57) ABSTRACT

A technique is disclosed for improving health care based upon genetic information. Genetic data, such as sequence data, hereditary data, and so forth, is accessed and relationships are identified with known health conditions and potential responses to the conditions. The compiled data is stored in a knowledge base for reference as conditions develop with individual patients.

### BACKGROUND

The present invention relates generally to the provision of healthcare and, more particularly to techniques for integrating genetic information with other available data to provide improved healthcare on an individualized basis.

Many techniques have been developed in the field of healthcare for evaluating the state of a patient's health and rendering treatment or care based upon the patient's condition and known treatments or responses. In general, healthcare has traditionally been reactive. That is, a condition may deteriorate to a point at which a patient notices a physical problem or pain, and the patient's conditions are evaluated by a physician to determine the root cause. Many tools have been made available to physicians in the diagnosis and treatment process. These include a wide range of clinical and non-clinical tests, imaging techniques, and so forth.

Over the past several decades, additional genetic information has become available to healthcare providers. While still in the nascent stages, further developments may be anticipated which will provide greater information on the genetic makeup of populations or portions of populations, and that of particular patients. Increasing research will also reveal links among these genetic definitions and health conditions, predispositions for health conditions, and the like. However, at present no unified and integrated system has been put in place for collecting, correlating, and making available such information. Moreover, there is a need in the healthcare field for an integrated system that offers more proactive evaluation of a physical state of a patient on a personalized basis, taking into account any or all of the traditional inputs used to evaluate the health of a patient, in addition to genetic information.

### BRIEF DESCRIPTION

The present invention provides techniques designed to respond to such needs. The invention may be used in a range of settings, and based upon various networks, business plans, and so forth. In general, the techniques provide for accessing and accumulating information relating to genetic makeup of known populations. The information may include entire gene sequences, portions of sequences, or information indicative of a genetic makeup, such as family history information, hereditary data, and other genetic indicators. Information is also collected relating the genetic data to known disease states or physical conditions. Additional data is collected relating to responses to such medical conditions. These responses may include, for example, treatments, therapies, recommendations for behavioral changes, recommendations for additional testing, among others. The collected data is then stored in an integrated genetic knowledge base (IGKB). This IGKB, then, serves as a resource for providing personalized healthcare to individual patients. The IGKB may be corrected or updated over time as new information becomes available, as genetic information and markers become associated with health conditions and diseases, as new treatments become known, and so forth.

The present techniques also provides for personalize healthcare based upon genetic data in conjunction with additional data. The IGKB described above may be employed as a reference tool. Genetic information, along with any other conventional healthcare data, is collected from a patient. The genetic information may be collected by actual gene sequencing, or may be inferred from other data and factors ascertainable from the patient. The collection of data, including the genetic data, may then be compared to information in the IGKB. Responses available through the IGKB may then be output to healthcare providers as an indication of possible responses and advice to patients.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a system for integrating genetic and other health data and for rendering personalized medical care based upon such data;

FIG. 2 is diagrammatical overview of certain components included in the system for creating an integrated genetic knowledge base;

FIG. 3 is a flow chart illustrating exemplary logic for processing a wide range of health data for incorporation in an IGKB;

FIG. 4 is tabulated illustration of the range of health data and sources from which such data may be drawn for incorporation in the IGKB; and

FIG. 5 is a diagrammatical illustration of an exemplary manner in which personalized healthcare may be provided based upon genetic and other data from a large population and an individual to which healthcare is to be rendered.

### DETAILED DESCRIPTION

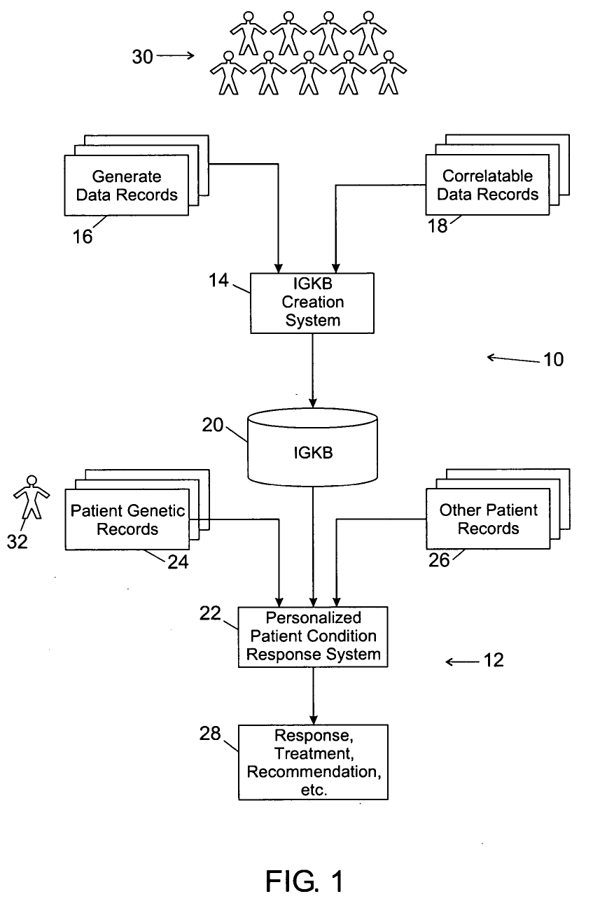

Turning now to the drawings, and referring first to FIG. 1, a system is illustrated that is designed to create an integrated genetic knowledge base and to utilize the knowledge base for rendering personalized healthcare to patients. It should be noted, that, as used herein, the terms “integrated genetic knowledge base” or “IGKB” is intended to connote a collection of interrelated and correlated data including data descriptive of genetic makeup of individuals and populations, other related non-genetic data, and to correlated data providing indications, symptoms or particular health conditions, data relating to the particular health condition which may be present in populations and patients, and data relating to responses to such conditions.

The IGKB may, in certain instances, be stored in a single computer system, such as in long-term memory that may be searched and update as desired. In other instances, however, the IGKB may be distributed over a network of systems such that the functionalities described herein may still be provided. Such networks may include interlinked computers, code including links to genetic databases, knowledge databases, electronic patient records, medical images, and so forth. In general, however, the IGKB will be defined by code stored on application-specific or general purpose computers and memory devices, with suitable interface software for performing detailed searches based upon inputs relating to detectable attributes of a particular patient.

As illustrated in FIG. 1, an IGKB system 10 is linked to a genetic healthcare system 12. In general, the IGKB system 10 enables the creation of the knowledge base, while the genetic healthcare system 12 utilizes the knowledge base to render personalized healthcare to individual patients. The IGKB system 10 includes an IGKB creation system 14 that draws information from a range of sources to provide the correlated data in the IGKB. As described in greater detail below, IGKB creation system 14 was typically drawn upon genetic data records 16 of various types. The genetic data records may relate to known populations, and to populations at large. It should be noted that the genetic data records may include correlations to know medical conditions and disease states, or may include simply raw genetic information, such as gene sequences.

The IGKB creation system 14 will also draw upon “correlatable” records that are not strictly genetic information. These records may include any range of conventional medical or health information as described in greater detail below. The records are termed, for the present purposes, “correlatable” because they can be combined with the genetic information to provide a more rich and complex definition of factors that may be included and indicators that may be reviewed for diagnosing and responding to disease states and health conditions.

The IGKB creation system 14 produces the IGKB 20 based upon such records. Noted above, the IGKB may be stored in a single location or may be distributed. Moreover, depending upon the nature of the IGKB and the strategy for its use, the IGKB may be available to users at no cost, such as in a library setting, or may be provided with limited use, such as on a subscription or as-needed basis. Compellation and consultation of the IGKB may, moreover, become collective through cooperation of a range of entities, such as entities providing input for its definition. Such structures and their operation will generally depend upon the business model used to implement the IGKB and accompanying personalized healthcare. Moreover, specific or targeted IGKB's may be envisaged, such as grouping particular types of conditions or disease states, particular populations, particular anatomies, and so forth. Each such IGKB may, of course, be separately managed.

As illustrated in FIG. 1, the genetic healthcare system 12 draws upon information from the IGKB which is utilized by a personalized patient condition response system 22. This condition response system 22 will typically include one or more programmed computers capable of extracting data from the IGKB and comparing the data to medical and health data for individual patients. As will be appreciated by those skilled in the art, the processing performed by the response system 22 may rely upon simple comparisons of values, ranges of values, matches among textual data, and so forth, but may also include highly complex rules and algorithms for defining responses. These may include, for example, algorithms for recognizing exact matches among data, algorithms for selecting features of interest within data, rules for permitting partial matches among data, rules for inclusion or exclusion of certain responses (i.e., limiting false positives or false negatives), and rules for prioritizing recommendations for responses.

The response system 22 will thus draw information from the IGKB 20 and from patient records. In general, the data relating to the individual patient may be included in patient genetic records 24 and in other patient records, indicated generally by reference numeral 26. The genetic records, which could be compiled over time or upon request by the patient or upon occurrence of a healthcare event, may include gene sequences, as well as other genetic information. Thus, conventional hereditary or family history information may be included which provides a direct or indirect indication of the genetic makeup or genetic predispositions of the patient. Where available, however, actual gene sequences may be preferred. The present technique provides a powerful tool in relating this information to the other patient records 26.

A range of other patient records may include medical records and information available from conventional healthcare providers. These may be provided, for example, in the form of an electronic patient record, or the information may be input as needed for computerized evaluation of the patient health condition in accordance with the present techniques. As described in greater detail below, the other patient records may include any useful medical information, such information as results in clinical and non-clinical evaluations and tests, patient behavioral data, habits and addictions, image data, and so forth. In conjunction with the genetic records, such other medical records provide a rich matrix or landscape of data which can be compared to similar data in the IGKB. The present techniques thus integrate genetic analysis and diagnosis with more conventional techniques in a seamless manner to provide a deeper and broader set of data for analysis and evaluation.

Based upon the evaluations performed by the personalized patient condition response system 22, various responses may be formulated and recommended as indicated at reference numeral 28 in FIG. 1. These responses may include, as described below, recommendations to the patient, as well as to recommendations of care providers and others. Such recommendations to patients may, for example, simply recommend changes in diet or behavior. However, more immediate or poignant recommendations may be made, such as for treatment, therapy, additional testing, and so forth. It should be noted, however, that the responses may be available to persons and entities other than the patient. Such persons and entities may include healthcare providers in evaluating patient needs and anticipating the need for healthcare resources, such as primary physicians and specialists, hospitals, and so forth. Insurers may make use of such information, for example, for setting applicable rates for health and life insurance, evaluating predispositions for conditions and diseases, and so forth.

The inventors stress, however, that in all of these scenarios, it is preferred that the data used to evaluation a patient condition be in the full control of the patient, and the patient's trusted healthcare provider. Applicants do not foresee scenarios for any use of the patient data outside of such considerations of patient control and express authorization.

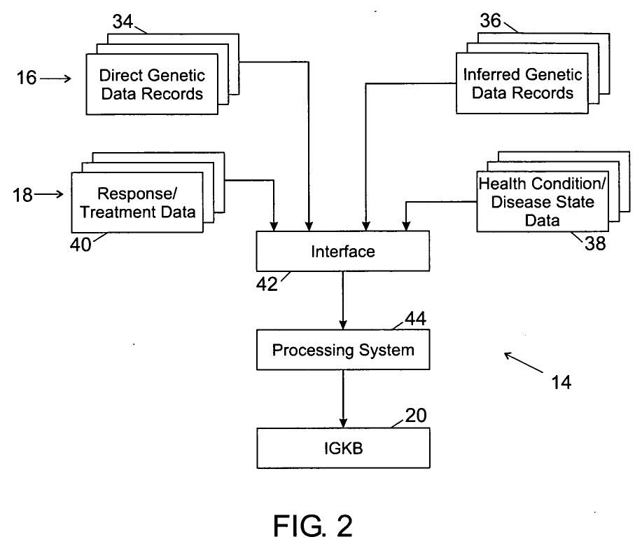

FIG. 2 illustrates exemplary components for compilation of the IGKB. As noted above, the IGKB creation system 14, illustrated generally in FIG. 2, will draw upon genetic data records 16 and well as correlatable records 18. As also noted above, the genetic data records 16 may include direct genetic data records 34 and inferred genetic data records 36. The direct genetic data records 34 may be collected over time, or may be generated at a particular point in time, such as when a healthcare condition has developed or becomes of interest. It should be noted that such data may become available from time to time, and the system 14 may update the IGKB based upon the availability of such data (e.g., from ongoing research). The present technique contemplates accessing such data from any available source, including public sources, paid private sources, proprietary sources, subscription sources, and so forth. The inferred genetic data records 36 will not generally include genetic sequences. That is, these records may include a wide range of hereditary data and related data indicating predispositions for medical conditions and health conditions. However, it is contemplated that the inferred genetic data records 36 will relate to genetic predispositions or certain medical conditions. That is, the records are not strictly limited to medical conditions that develop as a reaction to or from communicable diseases, environmental factors, accidents and trauma, and so forth.

The correlatable records 18 will generally include health condition/disease state data 38, and response and treatment data 40. As noted above, while certain medical and genetic data is becoming increasingly available, only some of this genetic data has been correlated to health conditions, disease states, predispositions for development of certain health conditions, and so forth. The present technique contemplates integrating such information, where available, and as such information becomes available. However, the present technique also contemplates collecting information on disease states and health conditions that are not already correlated to genetic data. That is, the creation of the IGKB may include making previously unrecognized correlations among health conditions and genetic makeup. By way of example, this may be performed by correlating the other health information from known populations, such as results of conventional medical testing and examination. Where such correlations appear to be strong, conclusions relating the population data may be made that correlate the genetic makeup, along with other test data with particular health conditions. Such correlations may be tested through further statistical analysis, surveys, inquiries, and clinical and non-clinical tests. Similar correlations are made with the responses summarized in the response/treatment data 40. Again, for known health conditions and disease states, such response data may be generally known and may already be associated with the health condition/disease state data 38. However, as new or improved treatments and responses become available, these can be added to the data 40 for integration into the IGKB.

In the illustration of FIG. 2, and interface 42 draws upon these records and resources for processing. As described more fully below, various types of interface may be employed. In general, these interfaces will identify records and data resources, analyze the resources and extract the data of interest for processing. A wide range of translation, structuring, indexing, and other functions may be performed by the interfaces, or by a processing system 44 to which the interfaces are linked. The processing system 44 will generally include one or more appropriately programmed computers which analyze the vast array of data available and correlate the data for the knowledge base. More will be said about the functioning of the processing system 44 below. Based upon the data processing performed by the interfaces and the processing system, then, the IGKB 20 is created and stored.

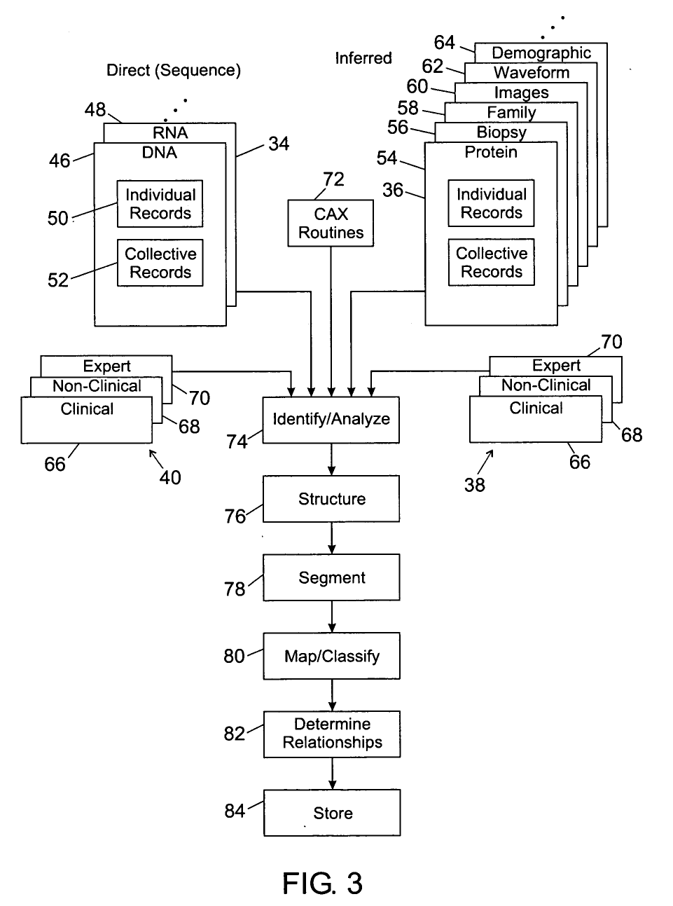

FIG. 3 illustrates exemplary logical steps in accessing and processing data for creation of the IGKB. As noted above, the direct genetic data records 34 may include genetic sequence data, such as sequences of DNA 46, RNA 48, or other molecules that provide an indication of genetic makeup. Such other indications may be, for example, in chromosomal DNA strands, extrachromosomal DNA, mitochondrial DNA strands, messenger RNA strands, and so forth. Moreover, the sequence data may be included in individual records 50 or in collective records 52, where available. Individual records, if accessed, will typically be stripped of identifying information. Such records may include entire gene sequences, or partial sequences of interest. Where records are available for populations, these may already include tags, identifiers of individual genes, identification of nucleotide polymorphisms, and other useful genetic data.

As also noted above, the IGKB will be based upon inferred genetic data records 36 and other data. This aspect of the present technique provides a powerful tool for the integration of genetic information with other more conventional medical information. In a presently contemplated approach, the records may include data describing proteins and protein structures 54, results of biopsies 56, family data, such as hereditary data from known or restricted populations 58, and so forth. Moreover, such data may include image data and images 60, waveform data 62, demographic data 64, and so forth. As will be appreciated by those skilled in the art, where available, such conventional resources may provide indications of disease states and health conditions in and of themselves. When correlated to and combined with genetic information, however, such resources can provide a powerful tool for confirming or disaffirming diagnoses and for recommending responses.

It should be noted that the various data identified and discussed herein may be correlated a priori, or may be correlated and related with one another by the IGKB creation system. That is, by way of example, genetic data may indicate the presence of a predisposition for a particular disease state, such as a cancer. Image data, on the other hand, can provide for automated analysis of anatomies which exhibit such cancers. When combined, the information provides for much more certain diagnosis, or may indicate that a certain diagnosis can be excluded. Other examples will likely come to light in which many such factors, both genetic and conventional will be combined in the IGKB for more rapid in diagnosis and response.

As indicated in FIG. 3, the health condition/disease state data 38 and a response/treatment data 40 may include various types of inputs. These may be, for example, clinical data 66, non-clinical data 68 and expert input 70. Again, in general, these will relate to specific known health conditions, their diagnosis, and response to them, such as treatment, therapy, additional testing, and so forth.

The present technique may also use of complex analysis routines which are either integrated into the IGKB creation system or called upon as needed for evaluation of individual data and records. As designated generally by reference numeral 72 in FIG. 3. Such “CAX” routines may include routines for computer aided diagnosis of health conditions, computer aided processing of acquired data, computer aided acquisition of medical data, and so forth. A range of such computer aided tools have been developed and are being further developed and deployed, particularly in such fields as medical image processing and analysis. The present technique is intended to permit any such routines to be drawn upon for analysis of the input records and data.

In general, the term “CAX” is intended to connote, quite generally, “computer aided” processing of any type. As will be appreciated by those skilled in the art, such techniques, common in the fields of image analysis, waveform analysis, and so forth, involve identification and segmentation of portions of data that may be of interest, followed by classification of the feature, where possible. By way of example, in the imaging field the algorithm may incorporate knowledge (typically defined by mathematical or statistical parameter values and ranges) of a particular anomaly condition may appear in a CT image, an MRI image, a mammographic image, an EKG waveform, and so forth. The CAX algorithm may then process images and other data to determine whether similar features are discemable from the image data, and match or classify the identified features based upon the known candidates and their characteristics. Such techniques may also be available or developed for identification of correlations in other patient data, including in particular gene sequences. These techniques also may be useful in relating the classified features to particular disease states or to recognized normal or anomaly conditions potentially of consequence.

As noted above, and as illustrated in FIG. 3, various data and records are provided to the interface described above and to the processing system to perform a variety of functions. First, the interface and processing systems perform identification and analysis of the data of interest as indicated at reference numeral 74. This identification may be based upon structure already present in the individual data entities for features of interest, or may be identified through the use of a CAX routine. Where desired, additional structure may be imposed on the extracted data as indicated at reference numeral 76. As will be appreciated by those skilled in the art, such structuring of the data may provide a very useful tool in later searching the knowledge base in a quick and accurate manner. A range of tools are available for such structuring, and more generally, the structure may be defined by the programming and structures desired in the knowledge base (i.e., based upon the categories, relationships labels, tags and so forth that define the IGKB).

At step 78 features of interest in the data and records may be segmented. While such segmenting techniques are well understood for certain types of image data, the segmenting intended for the IGKB may extend to any type of data. In general, such segmenting will involve defining a region or particular data of interest, and tagging or extracting the region for later analysis, identification and classification. Again, such processing may be made via routines called upon by the IGKB creation system. At step 80, then, and based upon such feature recognition, the data is mapped and classified, such as by the type of indicators of health condition, by the particular condition or diagnosis possible, and the possible responses to the condition. At step 82 these features and factors are correlated to identify interrelationships useful in sorting the indicators and for relating the indicators to similar data later received for a particular patient. At step 84 the IGKB is stored. The IGKB may include only the correlations among and among the data drawn upon by the creation system. However, storage of the IGKB may include storage of some or all of underlying data, or upon structured data derived from such data. The same is true of the algorithms used to identify and correlate the accessed data. These may be stored, where appropriate, with the IGKB or as part of it, or may be linked so as to be called upon when analysis and processing is later needed for individual patient healthcare. For example, where a particular gene sequence is correlated with clinical test data, indications of the sequence and the test data may be stored in the IGKB along with the correlation to provide a basis for comparison with similar information from a particular patient.

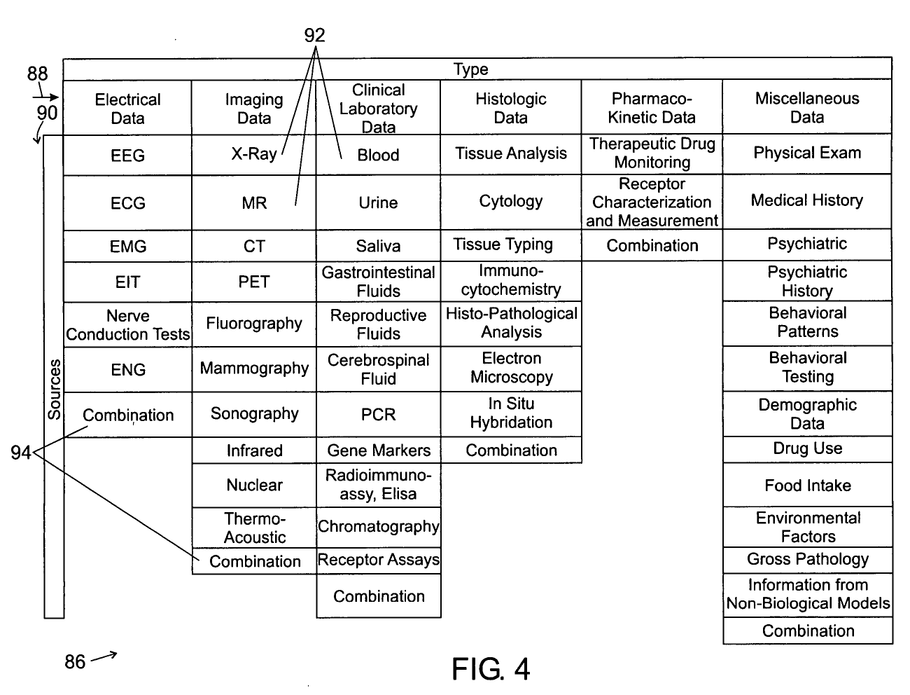

As noted above, the present technique not only draws upon direct and inferred genetic information, but integrates any suitable conventional indicators of health conditions or predispositions for health conditions. Exemplary conventional medical information sources that may be considered for generation of the IGKB, and for later use in providing personalized healthcare are summarized in FIG. 4. In general, data may be considered as variety of data acquisition sources 86 which can be represented in specific categories 88 indicative of their nature, physics, modes of acquisition, and so forth. Each category 88 includes individual sources 90 available to healthcare providers as an indication of patient health conditions. Individual sources 92 represent tools which can be prescribed for evaluating the patient health condition. Moreover, as will be appreciated by those skilled in the art, various ones of these individual sources may be combined as indicated at reference numeral 94 to provide more rich data indicative of specific types of health conditions.

As illustrated generally in FIG. 4, exemplary categories of data acquisition sources include electrical data, imaging data, clinical laboratory data, histologic data, pharmaco-kinetic data, and other miscellaneous data. Individual sources of data are available for each of these categories. Healthcare professionals will be well-acquainted with such sources, and prescribe tests on a routine basis that utilize such sources. For example, patients complaining of chest pain may undergo cardiac testing through ECGs, and also be tested for functioning of the heart via images made of the heart through CT scans. All of these test results may provide an indication of a particular predisposition for or the presence of a health condition or disease state.

The results of tests performed in such conventional manners may be stored in a range of locations and repositories. For example, image data may be stored in picture archiving and communications systems, whereas patient data resulting from physical exams may be stored in paper files, and electronic data bases at medical institutions and clinics. Where available, such records are unified to provide a more complete picture of the available patient data. Developments have been made and are being pursued for integration of such data into electronic patient records. The particular manner in which such records are compiled and the data which they contain are generally beyond the scope of the present technique. However, the present technique may make use of such electronic patient records for extracting data indicative of health conditions or predispositions for health conditions, and that are correlatable to genetic makeup or that are indirectly indicative of genetic makeup.

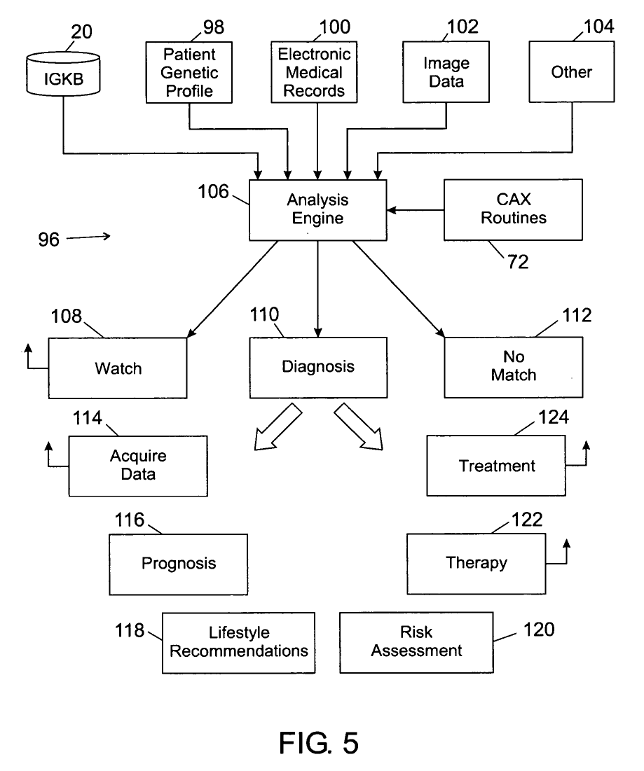

FIG. 5 provides a diagrammatical overview of an exemplary manner in which personalized healthcare may be rendered based upon an IGKB. As illustrated, a range of resources will be made available for this purpose, including the IGKB 20 itself, patient genetic profile information 98, any available electronic medical records 100 for the patient, image data 102, and any other useful medical or personal data 104. The patient genetic profile 98 may be acquired at the time the evaluation is made, or at any preceding time. It may be useful, for example, to obtain information on the genetic makeup of the patient at different points in time to indicate mutations, and changes in the genetic makeup or body chemistry of the individual or of particular tissues. The electronic medical records 100, as noted above, may include a wide range of conventional medical data for the individual. Image data 102, which may be part of the electronic medical record, may be drawn upon to include or exclude certain possibilities for diagnosis or response, for example. Other information 104 may include data which is acquired directly from the patient during an examination or interview that is not otherwise included in the other resources available.

The available data from the IGKB and from the patient is then provided to an analysis engine 106. The analysis engine 106, which will generally be defined by computer code in an appropriately programmed computer or a set of computers, performs comparisons and correlations among the information in the IGKB and that available or discemable through the other records and data provided. As noted above, such analysis may include simple comparisons of gene sequences, values in particular database fields, and so forth. However, the analysis engine may also perform or call upon routines to perform more complex evaluations, such as identification of near matches in genetic data, identification of portions of images that may be of interest, segmentation of anatomies and features of interest from images, extraction of values and parameters of waveform data, and so forth. For example, CAX routines discussed above may be called upon during the processing of the patient information. Based upon such analysis, a variety of recommendations may be made by the analysis engine.

In general, the analysis engine may make any suitable recommendation, typically depending upon the desired output. For example, where a predisposition for a medical condition is found, the output of the analysis may include a simple “watch” for further developments in the condition, as indicated by reference numeral 108. That is, where a medical condition is detected as being possible or likely, the patient may be scheduled for further tests, evaluations, or the like at future dates. The arrow from block 108 in FIG. 5 is intended to indicate that such follow-up may be recommended.

The analysis engine 106 may also make an actual diagnosis of a medical condition as indicated at reference numeral 110. As will be appreciated by those skilled in the art, such diagnoses may include indications of confidence levels, and will generally be reviewed and confirmed or disaffirmed by a medical profession. The inventors do not envision the present personalized healthcare approach as doing away with such confirmation and professional skill. Moreover, the analysis engine 106 may not be capable of making a match with a known condition in the IGKB. This information, too, may be returned to the user as indicated at reference numeral 112.

Where a diagnosis or potential diagnosis is made based upon the IGKB and the personal information from a particular patient, various recommendations may be made, and these may be made in a prioritized fashion. By way of example only, FIG. 5 illustrates that one recommendation may be to acquire additional data as indicated at reference numeral 114. This additional data, as indicated by the arrow from block 114, will typically be followed by additional evaluation once the data is available. Such acquisition may include acquisition of image data, clinical data, non-clinical data, genetic data, and so forth useful in completing, confirming or disaffirmiing a diagnosis or partial diagnosis made by the system.

Other recommendations or output from the system may include a prognosis 116, and lifestyle recommendations 118 (e.g., for altering behavior or habits of the patient). Similarly, risk assessments 120 may be made. Such risk assessments may be useful for the patient, as well as for other providers, such as care providers, insurers, and so forth.

Finally, various treatments and therapies may be recommended based upon the analysis, as indicated at reference numerals 122 and 124 in FIG. 5. Such therapies and treatments may include any conventional and newly developed therapies and treatments. Such therapies and treatments will generally be indicated by information within the IGKB, as described above. As indicated by the arrows leading from blocks 122 and 124 in FIG. 5, the various recommended therapies and treatments will generally be followed up by further evaluation, which may be made through the same IGBT-based analysis.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for generating a genetic knowledgebase comprising:
accessing genetic data defining a plurality of genetic states;
accessing health data defining a plurality of known health conditions;
accessing response data defining a plurality of responses to the health conditions;
determining relationships among the genetic states, the health conditions and the responses; and
storing the relationships.

2. The method of claim 1, wherein the genetic data includes data representative of genetic sequences for a known population.

3. The method of claim 1, wherein the genetic data includes data representative of hereditary conditions of a known population.

4. The method of claim 1, further comprising acquiring the genetic data by sequencing genes from a biological sample.

5. The method of claim 1, wherein the health data includes disease state descriptions correlatable to genetic states.

6. The method of claim 1, wherein the health data includes at least one of imaging data, laboratory data, electrical data, histological data pharmacokinetic data and miscellaneous data.

7. The method of claim 6, further comprising analyzing the health data to identify at least one health condition discemable from the health data.

8. The method of claim 1, wherein the response data includes data defining a health condition diagnosis, a health condition prognosis, a course of treatment, or a course of therapy.

9. The method of claim 1, wherein the response data includes an assessment of risk of development of a particular health condition.

10. The method of claim 1, wherein the response data includes a recommendation for acquisition of health data.

11. A method for generating a genetic knowledgebase comprising:
accessing genetic data defining a plurality of genetic states, the genetic data including gene sequence data for a known population;
accessing health data defining a plurality of known health conditions of the known population;
accessing response data defining a plurality of responses to the health conditions;
determining relationships among the genetic data, the health data and the response data; and
storing the relationships.

12. The method of claim 11, wherein the genetic data includes data representative of genetic sequences for a known population.

13. The method of claim 11, wherein the genetic data includes data representative of hereditary conditions of a known population.

14. The method of claim 11, further comprising analyzing the health data to identify at least one health condition discernable from the health data.

15. A method for generating a genetic knowledgebase comprising:
accessing genetic data defining a plurality of genetic states, the genetic data including gene sequence data for a known population;
accessing health data defining a plurality of known health conditions of the known population, the health data including medical image data;
accessing response data defining a plurality of responses to the health conditions;
analyzing the medical image data to identify at least one health condition discernable from the image data;
determining relationships among the genetic data, the health data and the response data; and
storing the relationships.

16. A method for generating a genetic knowledgebase comprising:
accessing genetic data defining a plurality of genetic states;
accessing health data defining a plurality of known health conditions;
accessing response data defining a plurality of responses to the health conditions;
structuring at least one of the genetic data, the health data and the response data;
determining relationships among the genetic states, the health conditions and the responses; and
storing the relationships and the structured data.

17. A computer program for generating a genetic knowledgebase comprising:
at least one machine readable medium;
computer code stored on the at least one machine readable medium including code for accessing genetic data defining a plurality of genetic states, accessing health data defining a plurality of known health conditions, accessing response data defining a plurality of responses to the health conditions, determining relationships among the genetic states, the health conditions and the responses, and storing the relationships.

18. A computer program for generating a genetic knowledgebase comprising:
at least one machine readable medium;
computer code stored on the at least one machine readable medium including code for accessing genetic data defining a plurality of genetic states, the genetic data including gene sequence data for a known population, accessing health data defining a plurality of known health conditions of the known population, accessing response data defining a plurality of responses to the health conditions, determining relationships among the genetic data, the health data and the response data, and storing the relatinoships.

19. A computer program for generating a genetic knowledgebase comprising:
at least one machine readable medium;
computer code stored on the at least one machine readable medium including code for accessing genetic data defining a plurality of genetic states, the genetic data including gene sequence data for a known population, accessing health data defining a plurality of known health conditions of the known population, the health data including medical image data, accessing response data defining a plurality of responses to the health conditions, analyzing the medical image data to identify at least one health condition discemable from the image data, determining relationships among the genetic data, the health data and the response data, and storing the relationships.

20. A computer program for generating a genetic knowledgebase comprising:
at least one machine readable medium;
computer code stored on the at least one machine readable medium including code for accessing genetic data defining a plurality of genetic states, accessing health data defining a plurality of known health conditions, accessing response data defining a plurality of responses to the health conditions, structuring at least one of the genetic data, the health data and the response data, determining relationships among the genetic states, the health conditions and the responses, and storing the relationships and the structured data.

21. An integrated genetic knowledgebase comprising:
correlations among genetic data defining a plurality of genetic states, health data defining a plurality of known health conditions, and response data defining a plurality of responses to the health conditions.
